(19) United States
(12) Patent Application Publication
(10) Pub. No.: US 2025/0316141 A1
(43) Pub. Date: Oct. 9, 2025

(54) AUTOMATED TELLER MACHINE (ATM) FEE GAMBLING

(71) Applicant: IGT, Las Vegas, NV (US)

(72) Inventors: Dwayne Nelson, Las Vegas, NV (US); Kevin Higgins, Reno, NV (US); Yan Ha, Reno, NV (US)

(21) Appl. No.: 18/626,923

(22) Filed: Apr. 4, 2024

(51) Int. Cl. G07F 17/32; G07F 19/00

(52) U.S. Cl. CPC G07F 17/3267; G07F 17/3223; G07F 17/323; G07F 17/3239; G07F 17/3272; G07F 19/20

(57) ABSTRACT

Embodiments of the present disclosure are directed to operating an Automated Teller Machine (ATM) to provide an electronic game on or through the ATM where the electronic provides a chance for a user to reduce transaction fees associated with a withdrawal. Accordingly, embodiments add a gambling feature at an ATM or kiosk which allows the user and option to play an electronic game in an attempt to reduce or win some or all the ATM transaction fee. The electronic game can be a game of chance or a skills-based game. In some cases, the game can be a multi-player game and the amount of reduction in the transaction fee, or even a award larger than the transaction fee, can depend upon an amount in a pot for the game.

### BACKGROUND

The present disclosure is generally directed to electronic gaming and more particularly to electronic gaming on or through an Automated Teller Machine (ATM).

In a casino or other establishment with gaming, e.g., a bar, gas station, etc., a customer might use an Automated Teller Machine (ATM) to withdraw cash for gaming. Associated with the transaction there may be a fee. This fee is typically a fixed amount such as $8, for example, but it could also be a percentage of the amount withdrawn. In casinos, this fee is larger than that found in a typical ATM outside the casino. In some cases, these fees may provide a disincentive to use the machines which can result in the players spending less thereby reducing revenue generated from games in the casino or establishment. Hence, there is a need in the art for improved systems and methods for operating an ATM or similar system.

### BRIEF SUMMARY

Embodiments of the present disclosure are directed to operating an Automated Teller Machine (ATM) to provide an electronic game on or through the ATM where the electronic provides a chance for a user to reduce transaction fees associated with a withdrawal. According to one embodiment, a method for operating an ATM can comprise initiating a withdrawal transaction with a user of the ATM. The withdrawal transaction can be associated with a fee having a pre-defined value. A prompt indicating an option to execute an electronic game on the ATM can be provided to the user through a display device of the ATM and a determination can be made as to whether the user has accepted the option to execute the electronic game on the ATM. The electronic game can comprise a game of chance or a skills-based game. In response to determining the user has accepted the option to execute the electronic game on the ATM, execution of the electronic game on the ATM can be initiated and a result of execution of the electronic game on the ATM can be determined.

In response to determining the result of execution of the electronic game on the ATM is a win result, the pre-defined value of the fee associated with the withdrawal transaction can be adjusted. Adjusting the pre-defined value of the fee associated with the withdrawal transaction can comprise decrementing the pre-defined value of the fee associated with the withdrawal transaction. For example, decrementing the pre-defined value of the fee associated with the withdrawal transaction can comprise decrementing the pre-defined value of the fee associated with the withdrawal transaction by an amount less than the pre-defined value of the fee associated with the withdrawal transaction. In another example, decrementing the pre-defined value of the fee associated with the withdrawal transaction can comprise decrementing the pre-defined value of the fee associated with the withdrawal transaction by an amount equal to the pre-defined value of the fee associated with the withdrawal transaction. In yet another example, decrementing the pre-defined value of the fee associated with the withdrawal transaction can comprise decrementing the pre-defined value of the fee associated with the withdrawal transaction by an amount greater than the pre-defined value of the fee associated with the withdrawal transaction. In such cases, currency in an amount equal to an amount for the withdrawal transaction plus a difference between the pre-defined value of the fee associated with the withdrawal transaction and the amount greater than the pre-defined value of the fee associated with the withdrawal transaction can be dispensed through a currency dispensing device of the ATM.

According to another embodiment, an ATM can comprise a display device, a processor coupled with the display device, and a memory coupled with and readable by the processor. The memory can have stored therein a set of instructions which, when executed by the processor, causes the processor to initiate a withdrawal transaction with a user of the ATM. The withdrawal transaction can be associated with a fee having a pre-defined value. The instructions can further cause the processor to provide, to the user, through the display device of the ATM, a prompt indicating an option to execute an electronic game on the ATM, determine whether the user has accepted the option to execute the electronic game on the ATM, and in response to determining the user has accepted the option to execute the electronic game on the ATM, initiate execution of the electronic game on the ATM. The instructions can further cause the processor determine a result of execution of the electronic game on the ATM and in response to determining the result of execution of the electronic game on the ATM is a win result, adjust the pre-defined value of the fee associated with the withdrawal transaction.

In some cases, the ATM can further comprise an input device and the instructions can further cause the processor to receive, through the input device, information related to an identity of the user, identify the user based on the received information related to the identity of the user, and verify an age of the user based on identifying the user. In such cases, providing the prompt indicating the option to execute the electronic game on the ATM can be performed in response to verifying the age of the user.

Additionally, or alternatively, the instructions can cause the ATM to track activity of the user. In such cases, providing the prompt indicating the option to execute the electronic game on the ATM can be performed based on tracking the activity of the user. In such cases, providing the prompt indicating the option to execute the electronic game on the ATM can be performed based on a number of times the user has accepted the option to execute the electronic game on the ATM in a predefined period of time, based on a number of losing results for user in the electronic game in a predefined period of time, or based on other considerations.

Additionally, or alternatively, the ATM can comprise a wireless communications interface. In such cases, the instructions can further cause the processor to communicate with a mobile device of the user through the wireless communications interface. Providing the prompt indicating the option to execute the electronic game on the ATM can be performed based on information received from the mobile device.

According to yet another embodiment, a system can comprise a display device, a processor coupled with the display device, and a memory coupled with and readable by the processor. The memory can have stored therein a set of instructions which, when executed by the processor, causes the processor to initiate a withdrawal transaction with a user of the system. The withdrawal transaction can be associated with a fee having a pre-defined value. The instructions can further cause the processor to provide, to the user, through the display device of the system, a prompt indicating an option to execute an electronic game, determine whether the user has accepted the option to execute the electronic game, in response to determining the user has accepted the option to execute the electronic game, determine a result of execution of the electronic game, and in response to determining the result of execution of the electronic game is a win result, adjust the pre-defined value of the fee associated with the withdrawal transaction.

In some cases, the instructions can cause the processor to execute the electronic game on the system. Additionally, or alternatively, the system can comprise a wireless communications interface and the instructions can cause the processor to communicate with a mobile device of the user. In such cases, the electronic game can be executed on the mobile device of the user and the instructions can further cause the processor to receive, from the mobile device of the user, through the wireless communications interface, an indication of the result of the electronic game.

In some cases, the electronic game can comprise a game played between a plurality of players. In such cases, adjusting the pre-defined value of the fee associated with the withdrawal transaction can comprise adjusting the pre-defined value of the fee associated with the withdrawal transaction by an amount of a value of a pot for the electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary Automated Teller Machine (ATM) according to one embodiment of the present disclosure.

FIG. 3 is a flowchart illustrating an exemplary process for operating an ATM or similar system according to one embodiment of the present disclosure.

FIG. 4 is a flowchart illustrating an exemplary process for operating an ATM or similar system according to another embodiment of the present disclosure.

FIG. 5 is a flowchart illustrating an exemplary process for operating an ATM or similar system according to another embodiment of the present disclosure.

FIG. 6 is a flowchart illustrating an exemplary process for operating an ATM or similar system according to another embodiment of the present disclosure.

### DETAILED DESCRIPTION

Embodiments of the present disclosure are directed to operating an Automated Teller Machine (ATM) to provide an electronic game on or through the ATM where the electronic game provides a chance for a user to reduce transaction fees associated with a withdrawal. Accordingly, embodiments add a gambling feature at an ATM or kiosk which allows the user an option to play an electronic game in an attempt to reduce or win some or all the ATM transaction fee. The electronic game can be a game of chance or a skills-based game. In some cases, the game can be a multi-player game and the amount of reduction in the transaction fee, or even an award larger than the transaction fee, can depend upon an amount in a pot for the game.

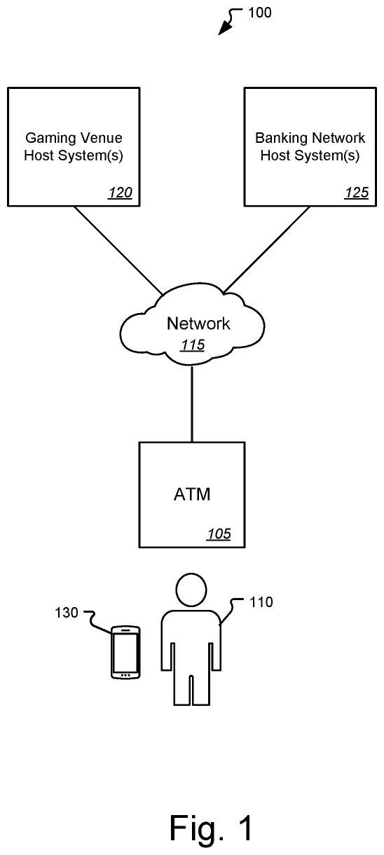

FIG. 1 is a block diagram illustrating an exemplary environment in which embodiments of the present disclosure can be implemented. As illustrated in this example, the environment 100 can comprise one or more ATMs 105, kiosks, or similar systems for dispensing currency to a user 110. The ATM 105 or similar system can be communicatively coupled with a communications network 115. The communications network 115 can comprise any one or more wired and/or wireless, local-area and/or wide-area networks as known in the art including, but not limited to, the Internet. Also coupled with the communications network 115 can be one or more gaming venue host systems 120 and/or one or more banking network hosts systems 125. Generally speaking, the gaming venue host system(s) 120 can comprise any one or more servers and/or other computing devices for monitoring and managing gaming systems, Electronic Gaming Machines (EGMs), and/or other systems or machines installed in a casino or other gaming venue in which the ATM 105 is located. The banking network host system(s) can comprise any number of servers and/or other computing devices to support and complete withdrawal, deposit, transfer, and/or other transaction initiated through the ATM 105.

Embodiments of the present disclosure provide a gaming feature through the ATM and through which the user 110 can gamble the ATM fee to lower the fee or eliminate the fee. In one example, the user 110 may withdraw $100 from the ATM 105 with an $8 fee such that $108 is withdrawn from the user's account and the user 110 is given $100 by the ATM 105. The user 110 can be given an option gamble to reduce or remove the $8 fee. In one embodiment, the user 110 can play a simple 50/50 game such as tossing a virtual coin on the display of the ATM 105. If the user 110 wins, the fee can be removed or not applied.

In one embodiment, the fee may be charged, but some or all the fee can be reimbursed in a secondary transaction. In one embodiment, the fee may not be charged until the outcome of the on-screen game is determined. For example, if the user 110 withdraws $100, the ATM 105 can show the user 110 that an $8 fee will be applied. The user 110 can then gamble and may wins the entire $8. The ATM 105 can then process the withdrawal of $100 from the user 110 account without the fee.

In one embodiment, the amount won by the user 110 can be a fraction of the fee. In the example, the user 110 might win back $3 of the $8 fee and therefore only be charged a $5 fee.

In one embodiment, the user 110 can be requested to provide at the ATM 105 identification information, such as a player tracking card or mobile application executing on the user's 110 mobile device 130. This can serve multiple purposes. First, it can be used to verify the age of the user 110 to confirm the user 110 can gamble fees. Second, it can allow a casino or other property to cater to player club members. In these embodiments, the user 110 can “log into” the system to enable the fee gambling feature.

In one embodiment, the user 110 can win the fee in addition to the withdraw amount. Imagine a system where the fee is $4 for a $100 withdrawal. In this embodiment, the user 110 might win $6 such that the user 110 then receives $102 from withdrawing $100 from their bank account. That is, they receive more than they withdraw. This allows the operator to configure the system such that it could charge on average $4 per $100, but still allow players to win up to $4, as an example.

The electronic game's playable on the ATM 105 can be a simple 50/50 or more complex games such as slot, poker, card, bingo, skill, memory, pattern matching, pick bonus or keno games. These games could have a paytable rather than a simple win/lose evaluation. This could lead to a paytable such as “3 cherries refunds $1”, “4 cherries refunds $3 dollars” and “5 cherries refunds $8” on a payline of a 5 reel game that includes a cherry symbol.

In another embodiment, the electronic game could be an instant sweepstakes, where the user 110 gets a virtual scratch ticket that they have to scratch off to see if they've won a rebate or award for their fees. This sweepstakes may be possible to enroll in without performing an ATM transfer if somebody submits a self-addressed stamped envelope to a designated address, but the expected value of single entry returned to the submitter can be less than the cost of an envelope and postage. This approach may be appealing since certain jurisdictions may not allow traditional gambling games on ATMs.

In another embodiment, all of or a portion of the ATM fee could be an entry fee into a contest where the user 110 could play against one or more contestants in real-time on the ATM 105 or their mobile device 130, where the winner of the contest earns the contest pot. This approach may be appealing since certain jurisdictions may not allow traditional gambling games on ATMs.

According to yet another embodiment, the ATM could dispense a coupon or coupon ticket or coupon code, or dispense to the user's club account, a discount on a future ATM fee. This discount may be used immediately, or it could require a certain date/time to be hit until it can be used. For example, a user could have to return to the casino or gaming venue next week to get a discount on their ATM fees.

In some embodiments, the gaming feature can be enabled or disabled based upon the withdrawal amount. For example, the gaming feature might be available on withdrawals greater than or equal to $100. In another example, the feature might be available on withdrawals less than or equal to $40.

In another embodiment, the gaming feature might be enabled or disabled based upon the user 110 performing withdrawals over a period of time, such as $100 over two days, or $100 transfers each day for 2 consecutive days, etc.

In one embodiment, the user 110 can have a mobile device 130 that is in communication with the ATM 105, e.g., via NFC, BluTooth, WiFi, etc. The user 110 can then play the game on the mobile device 130. This potentially allows for easier integration with the ATM 105. The user 110 can, for example, tap the mobile device 130 to a specified area of the ATM 105 or use a QR code to link the mobile device 130 to the ATM 105. The ATM 105 might have a QR code to download a gambling app for that ATM 105.

In one embodiment, the ATM or system tracks the activity of the player and disables the gambling feature for some players, such as players that have opted into a responsible gaming feature. In one embodiment, the ATM (or system) tracks the use of the gambling feature per bank card account and limits the gambling. For example, the ATM my limit a player to 4 gambles per day.

The ATM or system could limit one or more of number of times the gaming feature can be used per unit of time, e.g., per day, maximum number of gamble wins or losses per unit of time, e.g., per day, or other limitations to support responsible gaming. In one embodiment, the user 110 can opt into a responsible gaming feature, which disables the ATM 105 from offering the user 110 the gaming feature. The user 110 might opt into the feature at the ATM 105 or using a mobile application on the user's 110 mobile device 130. The gaming venue host system 120 can associate the user 110 bank account number, read from the banking card, with the user and associates the user options and activity with this account number.

In the embodiment where the user 110 uses a personal mobile device 130 for the refund game, the mobile application software or a host associated with the mobile application could track the user 110 usage of the refund game and apply the responsible gaming restrictions.

In one embodiment, the user 110 can attempt to download the mobile application using the QR code at the ATM 105. The mobile application can reach out to the gaming venue host system 120 and determines if the user 110 has opted into a responsible gaming list. In other words, the user 110 has joined a responsible gaming list. The mobile application might then deny the user 110 layer the use of the application or remove the application from the mobile device 130 according to the user's 110 previous instructions.

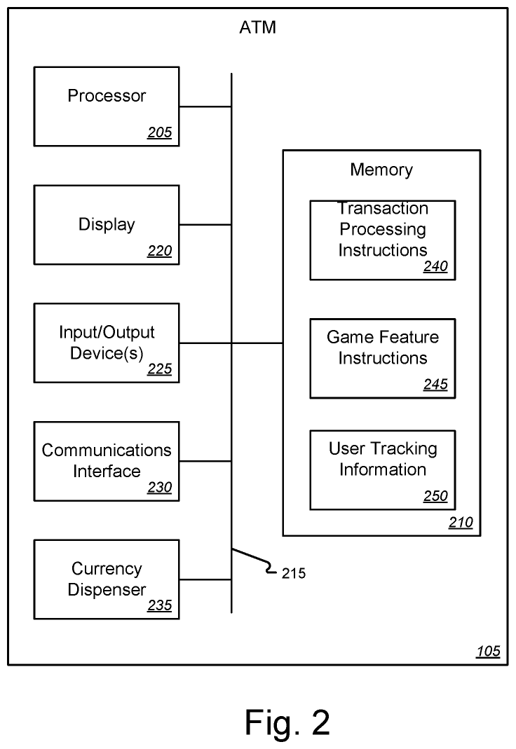

FIG. 2 is a block diagram illustrating additional details of components of an exemplary ATM or similar system according to one embodiment of the present disclosure. As illustrated in this example, an ATM 105 or similar system such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the ATM 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with a display device 220, one or more other input/output devices 225, one or more communication interface(s) 230, and currency dispenser device 235 via the communications bus 215. The display device 220 can comprises a Liquid Crystal Display (LCD), Light Emitting Diode (LED), Organic Light Emitting Diode (OLED), or other type of display, perhaps having a touch-sensitive layer to detect touch inputs by a user 110 or the ATM 105. The input/output devices 225 can comprise any number and/or types of devices as known in the art including, but not limited to, buttons, a mouse, a keypad, a keyboard, etc. The communication interface(s) 230 can comprise, for example, a Bluetooth, WiFi, cellular, and/or other type of wireless communications interface. Via the communication interface(s) 230, the ATM 105 can communicate with other systems and/or other devices through a communications network 115 as described above.

The memory 210 can store therein a set of instructions which, when executed by the processor 205, cause the processor 205 to perform the various functions of the ATM 105 or similar system as described above. For example, the memory 210 can have stored therein a set of transaction processing instructions 240 which, when executed by the processor 205, can cause the processor 205 to initiate a withdrawal transaction with a user 110 of the ATM 105. The withdrawal transaction can be associated with a fee having a pre-defined value.

The memory can also have stored therein a set of game feature instructions 245. The game feature instructions 245 can further cause the processor 205 to provide, to the user 110, through the display device 220 of the ATM, a prompt indicating an option to execute an electronic game. The electronic game can comprise a game of chance or a skills-based game. In some cases, the electronic game can comprise a game played between a plurality of players.

The game feature instructions 245 can further cause the processor 205 to determine whether the user has accepted the option to execute the electronic game, and in response to determining the user has accepted the option to execute the electronic game, initiate execution of the electronic game. Once initiated 435, the electronic game can execute on the ATM, on a mobile device 130 of the user 110, or a combination thereof.

The game feature instructions 245 can further cause the processor 205 determine a result of execution of the electronic game and in response to determining the result of execution of the electronic game on the ATM is a win result, adjust the pre-defined value of the fee associated with the withdrawal transaction. For example, adjusting the pre-defined value of the fee associated with the withdrawal transaction can comprise decrementing the pre-defined value of the fee associated with the withdrawal transaction. For example, decrementing the pre-defined value of the fee associated with the withdrawal transaction can comprise decrementing the pre-defined value of the fee associated with the withdrawal transaction by an amount less than the pre-defined value of the fee associated with the withdrawal transaction. In another example, decrementing the pre-defined value of the fee associated with the withdrawal transaction can comprise decrementing the pre-defined value of the fee associated with the withdrawal transaction by an amount equal to the pre-defined value of the fee associated with the withdrawal transaction. In yet another example, decrementing the pre-defined value of the fee associated with the withdrawal transaction can comprise decrementing the pre-defined value of the fee associated with the withdrawal transaction by an amount greater than the pre-defined value of the fee associated with the withdrawal transaction. In such cases, currency in an amount equal to an amount for the withdrawal transaction plus a difference between the pre-defined value of the fee associated with the withdrawal transaction and the amount greater than the pre-defined value of the fee associated with the withdrawal transaction can be dispensed through a currency dispensing device 235 of the ATM 105.

In some cases, the game feature instructions 245 can further cause the processor 205 to receive, through the input device(s) 225, information related to an identity of the user, identify the user based on the received information related to the identity of the user, and verify an age of the user based on identifying the user. In such cases, providing the prompt indicating the option to execute the electronic game can be performed in response to verifying the age of the user.

Additionally, or alternatively, the game feature instructions 245 can cause the processor 205 to track activity of the user 110. In such cases, providing the prompt indicating the option to execute the electronic game can be performed based on user tracking information 250 maintained in the memory 210 of the ATM 105 or elsewhere and read by the processor 205, e.g., through the communications interface(s) 230. In such cases, providing the prompt indicating the option to execute the electronic game can be performed based on a number of times the user has accepted the option to execute the electronic game in a predefined period of time, based on a number of losing results for user in the electronic game in a predefined period of time, or based on other considerations.

Additionally, the game feature instructions 245 can further cause the processor 205 to communicate with a mobile device 130 of the user 110 through the wireless communications interface(s) 230. Providing the prompt indicating the option to execute the electronic game can be performed based on information received from the mobile device.

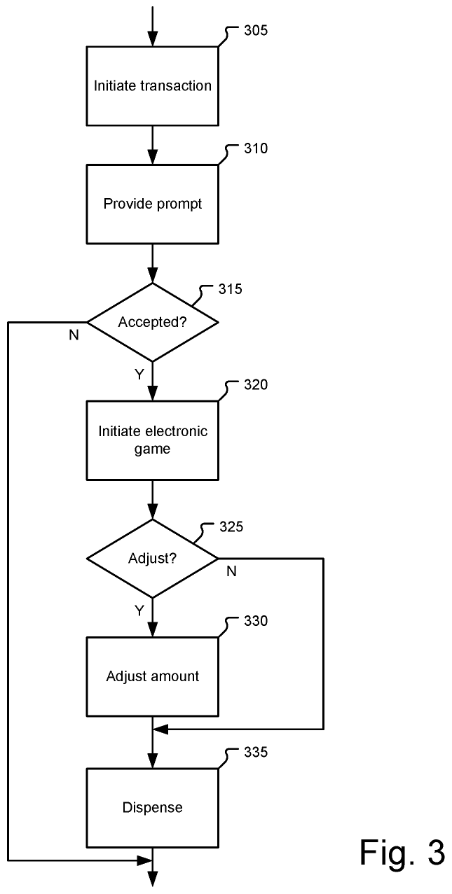

FIG. 3 is a flowchart illustrating an exemplary process for operating an ATM or similar system according to one embodiment of the present disclosure. As illustrated in this example, operating an ATM 105 or similar system can comprise initiating 305 a withdrawal transaction with a user 110 of the ATM 105. The withdrawal transaction can be associated with a fee having a pre-defined value. A prompt indicating an option to execute an electronic game can be provided 310 to the user 110 through a display device 220 of the ATM 105 and a determination 315 can be made as to whether the user 110 has accepted the option to execute the electronic game on the ATM 105. The electronic game can comprise a game of chance or a skills-based game. In some cases, the electronic game can comprise a game played between a plurality of players. In response to determining 315 the user has accepted the option to execute the electronic game, execution of the electronic game can be initiated 320 and a result of execution of the electronic game can be determined 325. Once initiated 320, the electronic game can execute on the ATM, on a mobile device 130 of the user 110, or a combination thereof.

In response to determining 325 the result of execution of the electronic game is a win result, the pre-defined value of the fee associated with the withdrawal transaction can be adjusted 330. In some cases, the electronic game can comprise a game played between a plurality of players. In such cases, adjusting 330 the pre-defined value of the fee associated with the withdrawal transaction can comprise adjusting the pre-defined value of the fee associated with the withdrawal transaction by an amount of a value of a pot for the electronic game. Adjusting 330 the pre-defined value of the fee associated with the withdrawal transaction can comprise decrementing the pre-defined value of the fee associated with the withdrawal transaction. For example, decrementing the pre-defined value of the fee associated with the withdrawal transaction can comprise decrementing the pre-defined value of the fee associated with the withdrawal transaction by an amount less than the pre-defined value of the fee associated with the withdrawal transaction. In another example, decrementing the pre-defined value of the fee associated with the withdrawal transaction can comprise decrementing the pre-defined value of the fee associated with the withdrawal transaction by an amount equal to the pre-defined value of the fee associated with the withdrawal transaction. In yet another example, decrementing the pre-defined value of the fee associated with the withdrawal transaction can comprise decrementing the pre-defined value of the fee associated with the withdrawal transaction by an amount greater than the pre-defined value of the fee associated with the withdrawal transaction. In such cases, currency in an amount equal to an amount for the withdrawal transaction plus a difference between the pre-defined value of the fee associated with the withdrawal transaction and the amount greater than the pre-defined value of the fee associated with the withdrawal transaction can be dispensed 335 through a currency dispensing device of the ATM.

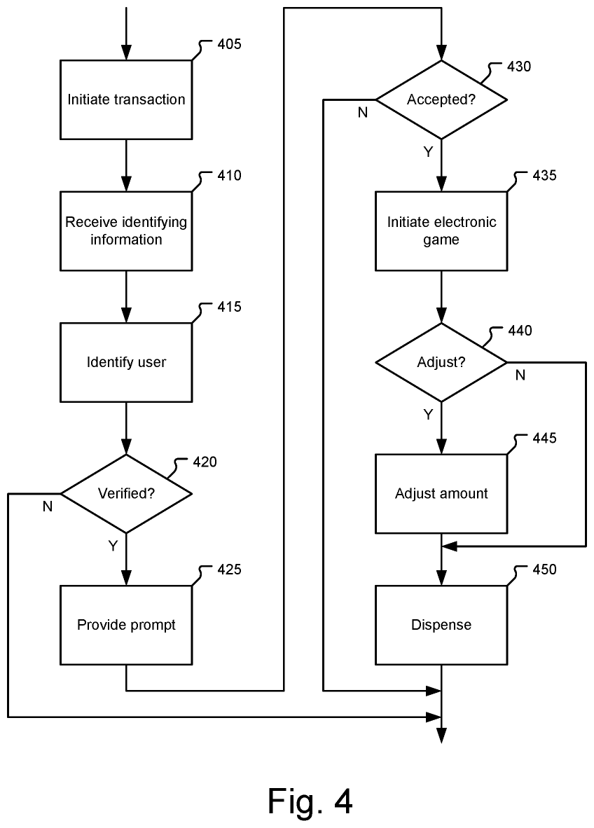

FIG. 4 is a flowchart illustrating an exemplary process for operating an ATM or similar system according to another embodiment of the present disclosure. As illustrated in this example, operating an ATM 105 or similar system can comprise initiating 405 a withdrawal transaction with a user 110 of the ATM 105. The withdrawal transaction can be associated with a fee having a pre-defined value. Information related to an identity of the user 110 can be received 410 through an input device 225 of the ATM 105 and the user can be identified 415 based on the received 410 information related to the identity of the user. An age of the user 110 can then be verified 420 based on identifying 415 the user 110.

In response to verifying 420 the age of the user 110, a prompt indicating an option to execute an electronic game can be provided 425 to the user 110 through a display device 220 of the ATM 105 and a determination 430 can be made as to whether the user 110 has accepted the option to execute the electronic game. In response to determining 430 the user 110 has accepted the option to execute the electronic game, execution of the electronic game can be initiated 435 and a result of execution of the electronic game can be determined 440. Once initiated 435, the electronic game can execute on the ATM, on a mobile device 130 of the user 110, or a combination thereof.

In response to determining 440 the result of execution of the electronic game is a win result, the pre-defined value of the fee associated with the withdrawal transaction can be adjusted 445 as described above and the adjusted amount of the withdrawal transaction can be dispensed 450 through a currency dispensing device of the ATM.

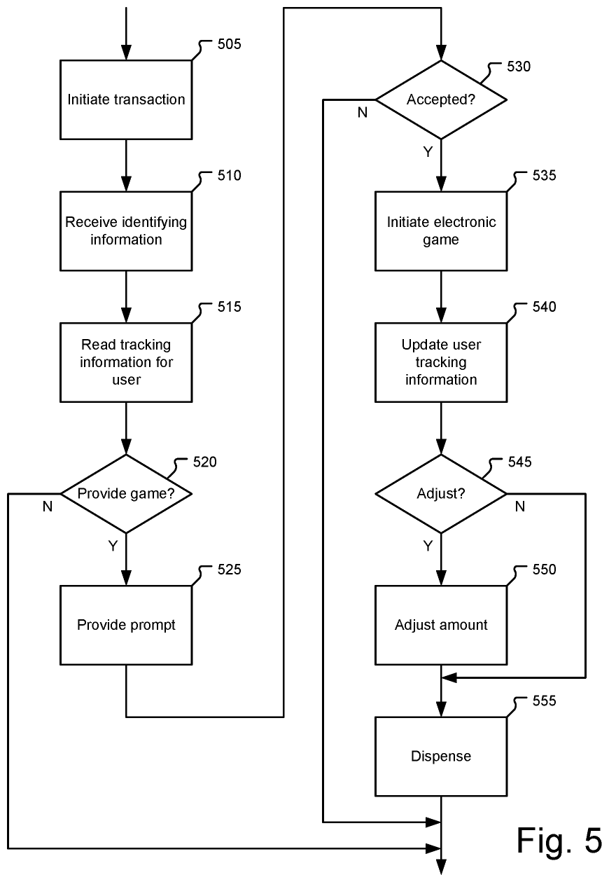

FIG. 5 is a flowchart illustrating an exemplary process for operating an ATM or similar system according to another embodiment of the present disclosure. As illustrated in this example, operating an ATM 105 or similar system can comprise initiating 405 a withdrawal transaction with a user 110 of the ATM 105. The withdrawal transaction can be associated with a fee having a pre-defined value. Information related to an identity of the user 110 can be received 510, e.g., through an input device 225 of the ATM 105. Based on the received 510 information related to the identity of the user, tracking information for that user, e.g., historical information related to the electronic game feature can be read 515. A determination 520 can then be made based on this tracking information as to whether to provide the electronic game feature. This determination 520 can be based on a number of times the user has accepted the option to execute the electronic game in a predefined period of time, based on a number of losing results for user in the electronic game in a predefined period of time, or based on other considerations.

In response to determining 520 to provide the electronic game feature, a prompt indicating an option to execute an electronic game can be provided 525 to the user 110 through a display device 220 of the ATM 105 and a determination 530 can be made as to whether the user 110 has accepted the option to execute the electronic game. In response to determining 530 the user 110 has accepted the option to execute the electronic game, execution of the electronic game can be initiated 535, user tracking information can be updated 540, and a result of execution of the electronic game can be determined 545.

In response to determining 545 the result of execution of the electronic game is a win result, the pre-defined value of the fee associated with the withdrawal transaction can be adjusted 550 as described above and the amount of the withdrawal transaction, perhaps minus the adjusted fee, in some cases, can be dispensed 555 through a currency dispensing device 235 of the ATM 110.

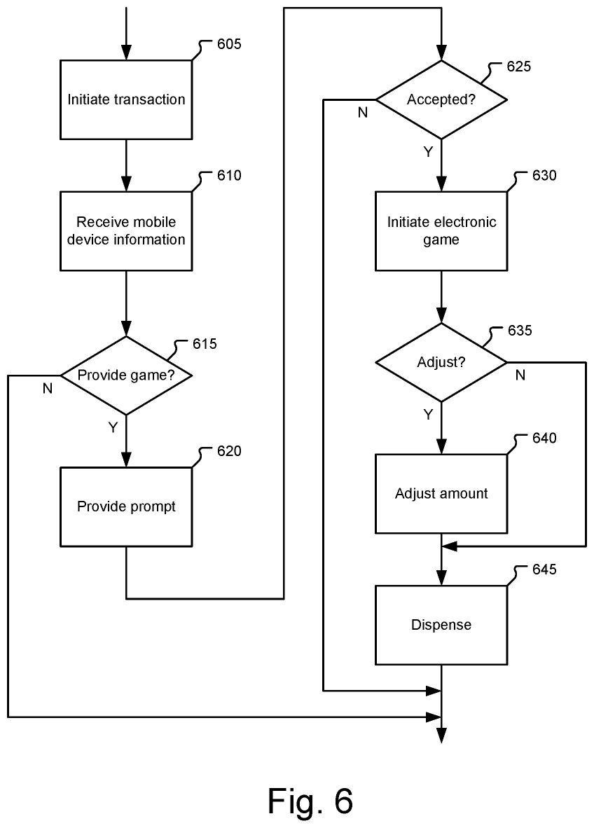

FIG. 6 is a flowchart illustrating an exemplary process for operating an ATM or similar system according to another embodiment of the present disclosure. As illustrated in this example, operating an ATM 105 or similar system can comprise initiating 605 a withdrawal transaction with a user 110 of the ATM 105. The withdrawal transaction can be associated with a fee having a pre-defined value. Information can be received 610, e.g., through a wireless communications interface 230 of the ATM 105 from a mobile device 130 of the user. A determination 615 can be made based on the received 610 information as to whether to provide the electronic game feature.

In response to determining 615 to provide the electronic game feature, a prompt indicating an option to execute an electronic game can be provided 620 to the user 110 through a display device 220 of the ATM 105 and a determination 625 can be made as to whether the user 110 has accepted the option to execute the electronic game. In response to determining 625 the user 110 has accepted the option to execute the electronic game, execution of the electronic game can be initiated 630 and a result of execution of the electronic game can be determined 635.

In response to determining 635 the result of execution of the electronic game is a win result, the pre-defined value of the fee associated with the withdrawal transaction can be adjusted 640 as described above and the amount of the withdrawal transaction, perhaps minus the adjusted fee, in some cases, can be dispensed 645 through a currency dispensing device 235 of the ATM 110.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating an Automated Teller Machine (ATM), the method comprising:
initiating, by a processor of the ATM, a withdrawal transaction with a user of the ATM, wherein the withdrawal transaction is associated with a fee having a pre-defined value;
providing, by the processor of the ATM, to the user, through a display device of the ATM, a prompt indicating an option to execute an electronic game on the ATM;
determining, by the processor of the ATM, whether the user has accepted the option to execute the electronic game on the ATM;
in response to determining the user has accepted the option to execute the electronic game on the ATM, initiating, by the processor of the ATM, execution of the electronic game on the ATM;
determining, by the processor of the ATM, a result of execution of the electronic game on the ATM; and
in response to determining the result of execution of the electronic game on the ATM is a win result, adjusting, by the processor of the ATM, the pre-defined value of the fee associated with the withdrawal transaction.

2. The method of claim 1, wherein the electronic game comprises a game of chance.

3. The method of claim 1, wherein the electronic game comprises a skills-based game.

4. The method of claim 1, wherein adjusting the pre-defined value of the fee associated with the withdrawal transaction comprises decrementing the pre-defined value of the fee associated with the withdrawal transaction.

5. The method of claim 4, wherein decrementing the pre-defined value of the fee associated with the withdrawal transaction comprises decrementing the pre-defined value of the fee associated with the withdrawal transaction by an amount less than the pre-defined value of the fee associated with the withdrawal transaction.

6. The method of claim 4, wherein decrementing the pre-defined value of the fee associated with the withdrawal transaction comprises decrementing the pre-defined value of the fee associated with the withdrawal transaction by an amount equal to the pre-defined value of the fee associated with the withdrawal transaction.

7. The method of claim 4, wherein decrementing the pre-defined value of the fee associated with the withdrawal transaction comprises decrementing the pre-defined value of the fee associated with the withdrawal transaction by an amount greater than the pre-defined value of the fee associated with the withdrawal transaction.

8. The method of claim 7, further comprising dispensing, by the processor of the ATM, through a currency dispensing device of the ATM, currency in an amount equal to an amount for the withdrawal transaction plus a difference between the pre-defined value of the fee associated with the withdrawal transaction and the amount greater than the pre-defined value of the fee associated with the withdrawal transaction.

9. An Automated Teller Machine (ATM) comprising:
a display device;
a processor coupled with the display device; and
a memory coupled with and readable by the processor and having stored therein a set of instructions which, when executed by the processor, causes the processor to:
initiate a withdrawal transaction with a user of the ATM, wherein the withdrawal transaction is associated with a fee having a pre-defined value;
provide, to the user, through the display device of the ATM, a prompt indicating an option to execute an electronic game on the ATM;
determine whether the user has accepted the option to execute the electronic game on the ATM;
in response to determining the user has accepted the option to execute the electronic game on the ATM, initiate execution of the electronic game on the ATM;
determine a result of execution of the electronic game on the ATM; and
in response to determining the result of execution of the electronic game on the ATM is a win result, adjust the pre-defined value of the fee associated with the withdrawal transaction.

10. The ATM of claim 9, further comprising an input device and wherein the instructions further cause the processor to:
receive, through the input device, information related to an identity of the user;
identify the user based on the received information related to the identity of the user; and
verify an age of the user based on identifying the user, wherein providing the prompt indicating the option to execute the electronic game on the ATM is performed in response to verifying the age of the user.

11. The ATM of claim 9, wherein the instructions further cause the ATM to track activity of the user and wherein providing the prompt indicating the option to execute the electronic game on the ATM is performed based on tracking the activity of the user.

12. The ATM of claim 11, wherein providing the prompt indicating the option to execute the electronic game on the ATM is performed based on a number of times the user has accepted the option to execute the electronic game on the ATM in a predefined period of time.

13. The ATM of claim 11, wherein providing the prompt indicating the option to execute the electronic game on the ATM is performed based on a number of losing results for user in the electronic game in a predefined period of time.

14. The ATM of claim 9, further comprising a wireless communications interface, wherein the instructions further cause the processor to communicate with a mobile device of the user through the wireless communications interface, and wherein providing the prompt indicating the option to execute the electronic game on the ATM is performed based on information received from the mobile device.

15. A system comprising:
a display device;
a processor coupled with the display device; and
a memory coupled with and readable by the processor and having stored therein a set of instructions which, when executed by the processor, causes the processor to:
initiate a withdrawal transaction with a user of the system, wherein the withdrawal transaction is associated with a fee having a pre-defined value;
provide, to the user, through the display device of the system, a prompt indicating an option to execute an electronic game;
determine whether the user has accepted the option to execute the electronic game;
in response to determining the user has accepted the option to execute the electronic game, determine a result of execution of the electronic game; and
in response to determining the result of execution of the electronic game is a win result, adjust the pre-defined value of the fee associated with the withdrawal transaction.

16. The system of claim 15, wherein the instructions further cause the processor to execute the electronic game on the system.

17. The system of claim 15, further comprising a wireless communications interface and the instructions further cause the processor to communicate with a mobile device of the user.

18. The system of claim 17, wherein the electronic game is executed on the mobile device of the user and wherein the instructions further cause the processor to receive, from the mobile device of the user, through the wireless communications interface, an indication of the result of the electronic game.

19. The system of claim 18, wherein the electronic game comprises a game played between a plurality of players.

20. The system of claim 18, wherein adjusting the pre-defined value of the fee associated with the withdrawal transaction comprises adjusting the pre-defined value of the fee associated with the withdrawal transaction by an amount of a value of a pot for the electronic game.
